(19) United States
(12) Patent Application Publication
(10) Pub. No.: US 2007/0124956 A1
(43) Pub. Date: Jun. 7, 2007

(54) Clothes Dryer CO Alarm

(75) Inventor: Andrew Crnkovich, Elmhurst, IL (US)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Richmond, VA (US)

(21) Appl. No.: 11/564,616

(22) Filed: Nov. 29, 2006

Related U.S. Application Data
(60) Provisional application No. 60/742,008, filed on Dec. 2, 2005.

(51) Int. Cl. F26B 19/00

(52) U.S. Cl. 34/551; 34/88; 34/89

(57) ABSTRACT

A gas clothes dryer having a carbon monoxide sensor incorporated therewith to detect the possibility and/or presence of a carbon monoxide that may be indicative of blockage in the exhaust vent or an improperly maintained appliance is provided. The dryer of the present invention incorporates carbon monoxide sensing to determine when an elevated level of carbon monoxide is present, and provides a warning to the consumer of the impending or existing hazardous condition. The warning may be audible, visual, and may include an interface to installed hazardous condition alarms within the dwelling. Additional interface to connected home systems providing text messaging may also be provided.

### CROSS-REFERENCE TO RELATED PATENT APPLICATIONS

This patent application claims the benefit of U.S. Provisional Patent Application No. 60/742,008, filed Dec. 2, 2005, the teachings and disclosure of which are hereby incorporated in their entireties by reference thereto.

### FIELD OF THE INVENTION

This invention generally relates to consumer and commercial appliances, and more particularly to a consumer or commercial clothes dryer.

### BACKGROUND OF THE INVENTION

Accidental Carbon Monoxide (CO) poisoning is a growing issue. Every year hundreds of people are sickened and many deaths occur due to Carbon Monoxide poisoning, principally from improperly vented or maintained appliances. Ten states now require the installation of CO alarms in residential new construction and several metropolitan areas, including Chicago and New York City, require CO alarms in all residential dwellings.

Gas-fired clothes dryers are a significant source of Carbon Monoxide and improperly vented dryers have resulted in several confirmed deaths in the past few years. Additionally, blockages that may result from lint build-up even in properly vented dryers can result in poor exhausting and a build up of CO.

There exists, therefore, a need in the art for a consumer and commercial clothes dryer that is able to detect such a condition and reduce the impact thereof.

The invention provides such a clothes dryer. These and other advantages of the invention, as well as additional inventive features, will be apparent from the description of the invention provided herein.

### BRIEF SUMMARY OF THE INVENTION

In view of the above, an embodiment of the present invention provides a new and improved clothes dryer. More particularly, an embodiment of the present invention provides a new and improved clothes dryer that can sense the production and/or build up of carbon monoxide thereby and act to reduce the generation and/or effect of such condition.

In one embodiment of the present invention, a Carbon Monoxide (CO) sensor is incorporated into residential clothes dryers to monitor CO gas levels in the vicinity of the dryer. The presence of elevated CO levels in the vicinity of a gas-fired dryer, beyond that associated with normal operating conditions, could be indicative of venting issues (blocked, damaged or an improperly installed vent) that could result in potentially dangerous levels of CO entering the home.

In one embodiment of the present invention, once the elevated level of CO is detected, the clothes dryer alerts the user to the condition. The alert may be audible and/or visual. In another embodiment, the clothes dryer disables operation of the burner to minimize the further production of carbon monoxide.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric illustration of a clothes dryer constructed in accordance with the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

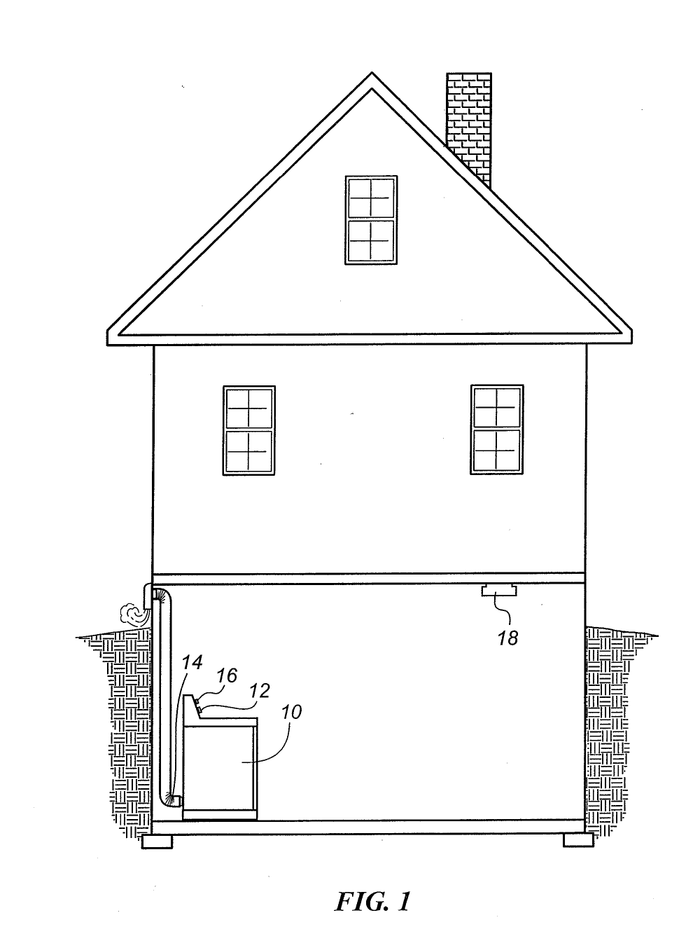

Referring to FIG. 1, a typical dwelling 20 is illustrated having a basement in which is installed a clothes dryer 10 constructed in accordance with the teachings of the present invention. This clothes dryer 10 includes a carbon monoxide sensor 12 positioned so that it can sense the level of carbon monoxide in the ambient air of the room in which the dryer 10 is located. In the illustrated embodiment, the CO sensor 12 is positioned on the control panel of the dryer 10 so that it can easily sense the ambient environment around the dryer 10 for the presence of CO. However, those skilled in the art will recognize that the CO sensor 12 may also be positioned elsewhere on or in the dryer 10 in locations that allow sensing of the ambient environment, including in the air intake for the dryer 10 for models that draw air from the ambient environment of the room in which the dryer 10 is located. Indeed, those skilled in the art will also recognize that on the control panel also includes mounting of the CO sensor 12 behind the control panel with appropriate vents being provided to allow sensing of the ambient environment outside of the dryer housing.

In one embodiment, the CO sensor 12 is an electrochemical CO sensor. This CO sensor 12 is incorporated into the clothes dryer 10 and continuously monitors the level of CO in the vicinity of the dryer 10. In an alternate embodiment, the CO sensor 12 monitors the level of CO in the vicinity of the dryer 10 only during operation of the dryer. According to the Consumer Products Safety Commission (CPSC), the health effects of CO depend on the level of CO and length of exposure, as well as each individual's health condition. The concentration of CO is measured in parts per million (ppm). Health effects from exposure to CO levels of approximately 1 to 70 ppm are uncertain, but most people will not experience any symptoms. Some heart patients might experience an increase in chest pain. As CO levels increase and remain above 70 ppm, symptoms may become more noticeable (headache, fatigue, nausea). As CO levels increase above 150 to 200 ppm, disorientation, unconsciousness, and death are possible.

In the event unusual levels of CO are detected that may indicate a problem condition, the sensor 12 may interrupt operation of the dryer 10, directly or via the dryer controller or other circuitry, to stop further production of CO. Indeed, as used herein for ease of understanding, interruption of the dryer 10 operation by the CO sensor 12 shall include interruption via the dryer controller or other circuitry based on the detection of CO by the CO sensor 12. This interruption may include disabling the burner of the dryer 10 to stop further production of CO. In an embodiment of the present invention, the dryer 10 may also stop the blower of the dryer 10 in addition to the burner. However, in another embodiment, the blower is allowed to continue to operate, or may be started so as to aid in venting the detected CO in the vicinity of the dryer 10.

The CO levels that trigger this interruption of the dryer 10 may be similar as those currently used to activate a CO alarm in standard CO detectors installed today (UL 2034), e.g. an inverse relationship between the level of CO concentration and the time duration of exposure. Alternatively, the threshold may be lower than the levels that would trigger a CO detector to sound its alarm, e.g. less than 30 ppm. Indeed, embodiments of the present invention disable the dryer 10 based on the detection of CO or the detection of CO above a certain level.

In an embodiment of the present invention, the clothes dryer 10 may sound a continuous or discontinuous audible warning to alert the homeowner to a potential problem. The alarm must be manually silenced in one embodiment. In a further embodiment, a visual alarm indicator 16 (i.e. LED) is enabled to help the homeowner understand the nature of the alarm.

If the home is equipped with RF enabled carbon monoxide alarms 18, a signal is sent from the dryer 10 causing the alarms 18 to activate. If the home is equipped with a smart or connected home system, such as the Samsung Homevita system, a text message alerting the homeowner to the condition may also be sent over the gateway.

The dryer 10 preferably would incorporate a long-life CO sensor 12, such as a sensor that utilizes the Invensys Monox™ self-test technology, and would preferably be field serviceable. In the event the sensor 12 is not functioning, a visual and/or audible signal would alert the homeowner to replace the sensor. The dryer would continue to function normally in this condition in one embodiment, and would be disabled in an alternate embodiment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A gas clothes dryer, comprising:
a housing;
a carbon monoxide (CO) sensor positioned relative to the housing to sense an ambient environment in which the gas clothes dryer is located to detect the presence of CO;
and wherein the CO sensor interrupts normal operation of the gas clothes dryer upon detection of CO in the ambient environment in which the gas clothes dryer is located.

2. The gas clothes dryer of claim 1, wherein the housing includes a control panel, and wherein the CO sensor is located on the control panel.

3. The gas clothes dryer of claim 1, wherein the housing includes an air intake, and wherein the CO sensor is located in the air intake.

4. The gas clothes dryer of claim 1, further comprising a blower positioned within the housing to draw air from the ambient environment through an air intake for use in drying clothes, and wherein the CO sensor energizes the blower upon detection of CO in the ambient environment in which the gas clothes dryer is located.

5. The gas clothes dryer of claim 1, further comprising a burner positioned within the housing to heat air from the ambient environment for use in drying clothes, and wherein the CO sensor disables the burner upon detection of CO in the ambient environment in which the gas clothes dryer is located.

6. The gas clothes dryer of claim 5, further comprising a blower positioned within the housing to draw air from the ambient environment through an air intake for use in drying clothes, and wherein the CO sensor de-energizes the blower upon detection of CO in the ambient environment in which the gas clothes dryer is located.

7. The gas clothes dryer of claim 1, wherein the CO sensor transmits an alarm activation signal to an external CO detector to activate its alarm upon detection of CO in the ambient environment in which the gas clothes dryer is located.

8. The gas clothes dryer of claim 1, wherein the CO sensor transmits a text message to a smart home gateway upon detection of CO in the ambient environment in which the gas clothes dryer is located.

9. The gas clothes dryer of claim 1, further comprising a visual indicator positioned on the housing, and wherein the CO sensor activates the visual indicator when the CO sensor detects a presence of CO.

10. The gas clothes dryer of claim 9, wherein the visual indicator is an light emitting diode (LED).

11. The gas clothes dryer of claim 1, further comprising an audible indicator, and wherein the CO sensor activates the audible indicator when the CO sensor detects a presence of CO.

12. The gas clothes dryer of claim 1, further comprising an audible indicator and a visual indicator, and wherein the CO sensor activates the audible indicator and the visual indicator when the CO sensor detects a presence of CO.

13. The gas clothes dryer of claim 1, wherein the CO sensor is a self-testing CO sensor.

14. The gas clothes dryer of claim 13, further comprising an audible alarm, and wherein the audible alarm is triggered when the self-testing CO sensor determines that it is not functioning properly.

15. The gas clothes dryer of claim 13, further comprising a visual alarm, and wherein the visual alarm is triggered when the self-testing CO sensor determines that it is not functioning properly.

16. The gas clothes dryer of claim 1, further comprising a burner positioned within the housing to heat air from the ambient environment for use in drying clothes, and wherein the CO sensor turns off the burner when the CO sensor detects a level of CO above a predetermined threshold.

17. The gas clothes dryer of claim 1, further comprising a burner positioned within the housing to heat air from the ambient environment for use in drying clothes, and wherein the CO sensor turns off the burner when the CO sensor detects a level of CO for a period of time.

18. The gas clothes dryer of claim 17, wherein the level of CO is inversely related to the period of time.

19. A method of increasing the safety of drying clothes with a gas clothes dryer, comprising the steps of:
monitoring for carbon monoxide (CO) in an ambient environment in which the gas clothes dryer is located;
disabling a gas burner of the gas clothes dryer when the step of monitoring detects the presence of CO in the ambient environment in which the gas clothes dryer is located.

20. The method of claim 19, further comprising the step of alerting a user of the gas clothes dryer when the step of monitoring detects the presence of CO in the ambient environment in which the gas clothes dryer is located.
